(19) United States
(12) Patent Application Publication
(10) Pub. No.: US 2020/0367025 A1
(43) Pub. Date: Nov. 19, 2020

(54) COMBINATION SYSTEM AND METHOD

(71) Applicant: Irad DEUTSCH, Bnei Atarot (IL)

(72) Inventor: Eliran MALKI, Bnei Atarot (IL)

(21) Appl. No.: 16/759,032

(22) PCT Filed: Oct. 24, 2018
(86) PCT No.: PCT/IL2018/051150

§ 371 Date: Apr. 24, 2020

Related U.S. Application Data
(60) Provisional application No. 62/576,126, filed on Oct. 24, 2017.

(51) Int. Cl. H04W 4/14; H04L 12/58; H04L 29/08

(52) U.S. Cl. CPC H04W 4/14; H04L 67/26; H04L 51/38

(57) ABSTRACT

A combination system including: (a) a sending message server; (b) at least one triggering signal packet sent from said sending message server; and (c) at combination device responsive to receiving said at least one triggering signal packet.

### FIELD AND BACKGROUND OF THE INVENTION

The present invention relates to a combination two way communication device for combining a communication device responsive to a download electronic signal packet from a sending message server, and in particular, to such a combination device in which the device is responsive to a user touching a screen on the device, triggering sending an electronic signal packet returning to the sending message server.

Adding text messaging functionality to mobile devices is well known in the art. Currently, many different messaging systems are used by users are available, including those which are text messaging services component of telephone, World Wide Web, and mobile telephony systems.

Invariably, such systems utilize standardized communication protocols to enable mobile phone devices to exchange short text messages. An intermediary service can facilitate a text-to-voice conversion to be sent to landlines.

Though most SMS messages are mobile-to-mobile text messages, support for the service has expanded to include other mobile technologies, such as ANSI CDMA networks and Digital AMPS.

Messaging has been optimized for telephony, wherein SMS messaging is for use with a telephone-optimized system, and to transport messages on signaling paths needed to control telephone traffic during periods when no signaling traffic existed. Thus, unused resources in a system are readily used to transport messages at a minimal cost. However, SMS messaging was originally limited as a necessity to limit message length to 128 bytes (later improved to 160 seven-bit characters) such that messages could fit into the existing signaling formats and based on observations and on analysis of the typical lengths of postcard and Telex messages.

Furthermore and as well known in the art, SMS gateway providers facilitate SMS traffic between businesses and mobile subscribers, including SMS for enterprises, content delivery, and entertainment services involving SMS, such as. TV voting and the like.

Considering SMS messaging performance and cost, as well as the level of messaging services, SMS gateway providers can be classified as aggregators or SS7 providers. The aggregator model is based on multiple agreements with mobile carriers to exchange two-way SMS traffic into and out of the operator's Short Messaging Service Center (SMSC), also known as local termination model. Aggregators lack direct access into the SS7 protocol, which is the protocol where the SMS messages are exchanged. SMS messages are delivered to the operator's SMSC, but not the subscriber's handset; the SMSC takes care of further handling of the message through the SS7 network.

Furthermore, Short messages can send binary content such as ringtones, logos, Over-the-air programming (OTA) and configuration data. Such uses are a vendor-specific extension of the GSM specification and there are multiple competing standards, although the Smart Messaging standard is common. An alternative way for sending such binary content is EMS-messaging, which is standardized and not dependent on vendors.

SMS is used for M2M (Machine to Machine) communication. For instance, there is an LED display machine controlled by SMS which provides for some vehicle tracking companies to use SMS for their data transport or telemetry needs. SMS usage for these purposes is slowly being superseded by GPRS services owing to their lower overall cost and as GPRS is offered by smaller telco players as a route of sending SMS text to reduce the cost of SMS texting internationally.

Also, Threaded SMS is a visual styling orientation of SMS message history for arranging messages to and from a contact in a chronological order on a single screen. Threaded SMS systems are geared towards utilizing a blank screen left below the message on a device with a larger screen capable of displaying more than 160 characters, and according to the teachings of threaded Reply conversations in email. Visually, this style of representation provides a back-and-forth chat-like history for each individual contact. Hierarchical-threading at the conversation-level (as typical in blogs and on-line messaging boards) is not widely supported by SMS messaging clients. This limitation is due to the fact that there is no session identifier or subject-line passed back and forth between sent and received messages in the header data (as specified by SMS protocol) from which the client device can properly thread an incoming message to a specific dialogue, or even to a specific message within a dialogue. Most smart phone text-messaging-clients are able to create some contextual threading of “group messages” which narrows the context of the thread around the common interests shared by group members. On the other hand, advanced enterprise messaging applications which push messages from a remote server often display a dynamically changing reply number (multiple numbers used by the same sender), which is used along with the sender's phone number to create session-tracking capabilities analogous to the functionality that cookies provide for web-browsing. As one pervasive example, this technique is used to extend the functionality of many Instant Messenger (IM) applications such that they are able to communicate over two-way dialogues with the much larger SMS user-base. In cases where multiple reply numbers are used by the enterprise server to maintain the dialogue, the visual conversation threading on the client may be separated into multiple threads.

While SMS messaging has reached its popularity as a person-to-person messaging, application-to-person (A2P) messaging is growing in use. A2P is a type of SMS sent from a subscriber to an application or sent from an application to a subscriber. It is commonly used by financial institutions, airlines, hotel booking sites, social networks, and other organizations sending SMS from their systems to their customers. Presently, in the USA, A2P messages must be sent using a short code rather than a standard long code which has an impact on the usage and limits certain application thereof.

SMS messaging known in the art also includes Flash SMS messaging that appears directly on the main screen without user interaction and is not automatically stored in the inbox. Flash SMS messaging has been found to be useful in emergencies, such as a fire alarm or cases of confidentiality, as in delivering one-time passwords.

Another messaging system known in the art, includes Silent messages, also known as “silent TMS”, “stealth SMS”, “stealth ping” or “Short Message Type 0”, commonly used to locate a person and thus to create a movement profile or location profile. Silent messages do not show up on a display, nor trigger any acoustical signal when received. The primary purpose served by Silent messages is to deliver special services of the network operator to a cell phone. The mobile provider, often at the behest of governmental bodies, capture data such as subscriber identification IMSI and the like.

A latent deficiency of the systems described hereinabove, SMS message delivery is not guaranteed, and many implementations provide no mechanism through which a sender can determine whether an SMS message has been delivered in a timely manner. SMS messages are generally treated as lower-priority traffic than voice, and various studies have shown that around 1% to 5% of messages are lost entirely, even during normal operation conditions, and others may not be delivered until long after their relevance has passed. Thus, the use of SMS as an emergency notification service in particular has been widely questioned.

A further latent deficiency of the systems described hereinabove is that the Global Service for Mobile communications (GSM), with the greatest worldwide number of users, succumbs to several security vulnerabilities. In the GSM, only the airway traffic between the Mobile Station (MS) and the Base Transceiver Station (BTS) is optionally encrypted with an invariably weak and broken stream code. Further, GSM authentication is unilateral and also vulnerable. There are also other security vulnerabilities and shortcomings inherent to SMS as one of the superior and well-tried services with a global availability in the GSM networks. SMS messaging has some extra security vulnerabilities due to its store-and-forward feature, and the problem of fake SMS that can be conducted via the Internet. Further still, when a user is roaming, SMS content passes through different networks, occasionally including the Internet, and is exposed to various vulnerabilities and attacks. Another concern arises pursuant to a hostile element getting access to a phone and reading previously sent/received unprotected messages.

Researchers from Pennsylvania State University published an analysis of vulnerabilities in SMS-capable cellular networks. The researchers speculated that attackers might exploit the open functionality of these networks to disrupt them or cause them to fail, possibly even on a nationwide scale.

Yet a further latent deficiency of SMS messaging systems described hereinabove has been identified by the GSM industry is the potential of fraud attacks on mobile operators that can be delivered via abuse of SMS messaging services. The most serious threat known in the art is SMS Spoofing, which occurs when a hostile user manipulates address information in order to impersonate a user that has roamed onto a foreign network and is submitting messages to the home network. Frequently, these messages are addressed to destinations outside the home network—with the home SMSC essentially being “hijacked” to send messages into other networks.

The only sure way of detecting and blocking spoofed messages known in the art is to screen incoming mobile-originated messages to verify that the sender is a valid subscriber and that the message is coming from a valid and correct location. This can be implemented by adding an intelligent routing function to the network that can query originating subscriber details from the home location register (HLR) before the message is submitted for delivery. This kind of intelligent routing function is currently beyond the capabilities of legacy messaging infrastructure.

A further means of communications known in the art includes “Push notifications” facilitating users to be “pinged” when they were not using an app.

One such use can be found in the Current applications, wherein a user changing the user status is results in a notifying everyone in the user's network.

Current systems use a customized version of the open standard Extensible Messaging and Presence Protocol (XMPP). Upon installation, XMPP creates a user account using the phone number of the user as the username.

XMPP then automatically compares all the phone numbers from the user address book with the central database of Current system users to automatically add contacts to the Current system contact list. MD5-hashed, reversed-version of the phone's IMEI have been used as passwords, while the others have used the phone's Wi-Fi MAC address instead of IMEI or generate a random password on the server side.

Multimedia messages are also being used by uploading an image, audio or video to be sent to an HTTP server and then sending a link to the content along with its Base64 encoded thumbnail (if applicable).

Current systems follow a “store and forward” mechanism for exchanging messages between two users. When a user sends a message, it first travels to the Current systems server where it is stored. Then the Current systems server repeatedly requests the receiver to acknowledge receipt of the message. As soon as the message is acknowledged, the Current systems server drops the message and it is no longer available in the database of the Current systems server. Commonly, Current systems server keeps a message for 30 days in its database when it is not delivered (when the receiver is not active on Current systems for 30 days).

Unfortunately, although such systems are an improvement over SMS messaging systems the systems suffer from a latent deficiency of being susceptible to hijacking.

Flaws in authentication processes allow hostile users to hijack an account by trying to login with another phone number and intercepting the verification SMS text message that, under specific conditions, remained in the outbox of the device after the user client would attempt to send the verification to itself.

Furthermore, another security hole which leaves such communications susceptible to packet analysis as they are not encrypted, and data is sent and received in plaintext, meaning messages could easily be read if packet traces were available.

Such message systems are inherently vulnerable with respect to Message Handle Vulnerability, which allows anyone to remotely crash the communication system just by sending a specially crafted message. To escape the problem, the user who receives the specially crafted message has to delete his/her whole conversation and start a fresh chat, because opening the message keeps on crashing the system unless the chat is deleted completely.

Further still, most communication systems default state of automatically downloading attachments incurs the risk that once support for document sharing expanded beyond PDF files security may be impaired.

Privacy is often compromised by such systems inasmuch that known systems require users to upload their device's entire address book to the system servers so that the system could discover who, among the users' contacts, was available via the system. While this was a fast and convenient way to quickly find and connect the user with contacts who were also using the same system, it meant that the address book of the user was then mirrored on the system servers, including contact information for contacts who were not using the system. This information, which consisted solely of phone numbers without any additional information such as the name of the contact, was stored in the system in an accessible form.

Therefore, there is an unmet need for, and it would be highly useful to have, a secure and reliable combination two way communication device for combining a communication device responsive to a download electronic signal packet from a sending message server, and in particular, to such a combination device in which the device is responsive to a user touching a screen on the device, triggering sending an electronic signal packet returning to the sending message server.

### SUMMARY OF THE INVENTION

The present invention is of a combination two way communication device for combining a communication device responsive to a download electronic signal packet from a sending message server, and in particular, to such a combination device in which the device is responsive to a user touching a screen on the device, triggering sending an electronic signal packet returning to the sending message server.

According to the present invention, there is provided a combination system including: (a) a sending message server, (b) at least one triggering signal packet sent from the sending message server, and (c) at combination device responsive to receiving the at least one triggering signal packet.

### BRIEF DESCRIPTION OF THE DRAWINGS

The invention is herein described, by way of example only, with reference to the accompanying drawings, wherein:

FIG. 1. is a schematic block diagram of a first embodiment of the combination device of the present invention.

### DESCRIPTION OF THE PREFERRED EMBODIMENTS

The present invention is of a combination two way communication device for combining a communication device responsive to a download electronic signal packet from a sending message server, and in particular, to such a combination device in which the device is responsive to a user touching a screen on the device, triggering sending an electronic signal packet returning to the sending message server.

Preferred embodiments of the present invention enable a plurality of interactions between a system including a sending message server by way of an electronic trigger signal packet to a combination device triggering the combination device to provide a selective data signal packet response.

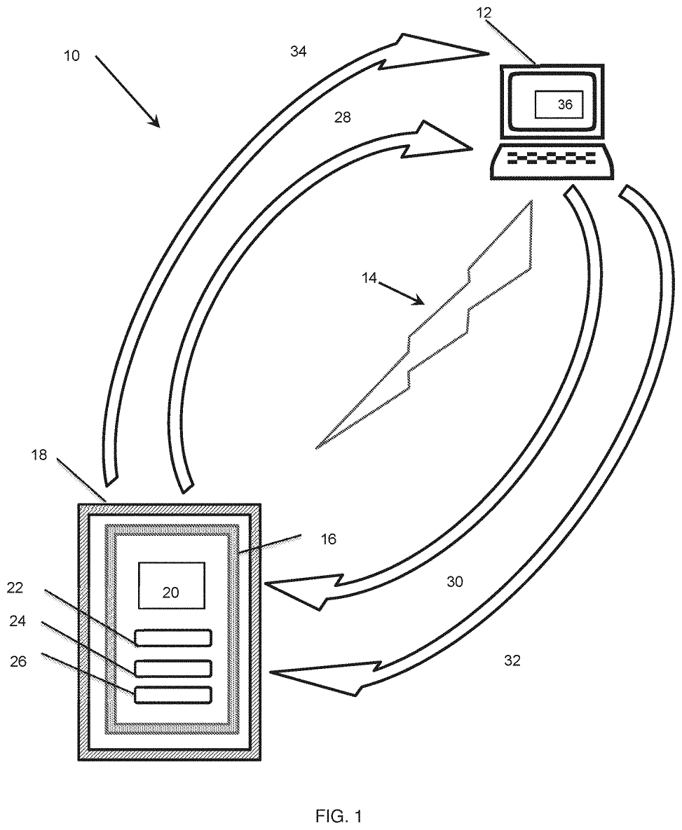

Referring now to the drawings, FIG. 1 show a schematic view of a first embodiment of a combination two way communication device for combining a communication device responsive to a download electronic signal packet from a sending message server. As shown in FIG. 1, combination system 10 features a sending message server 12, from which at least one triggering electronic signal packet 14 is sent to a combination device 16. As shown, combination device 16 is responsive to receiving triggering electronic signal packet 14.

Preferably, combination device 16 includes a hardware interface 18 for readily facilitating an actuation of a component selected from the group consisting of: a visual indicator 20, a first binary responder 22, a second binary responder 22 and at least one general responder 26.

Preferably, substantially subsequently to combination device 16 receiving at least one triggering electronic signal packet 14, combination device 16 sends a first user response 28 to sending message server 12.

Preferably, first user response 28 is selected from the group consisting of: an automatic response, a stealth response, a response actuated by visual indicator 20, a response actuated by first binary responder 22, a response actuated by second binary responder 24 and a response actuated by at least one general responder 26.

Optionally, sending message server 12 receives first user response 28 and processes data included therein without performing a transmission to combination device 16 in response to receiving first user response 28.

Preferably and substantially thereafter, sending message server 12 receives first user response 28, sending message server 12 is responsive to first user response 28 and sends a first server reply 30 created by sending message server 12 based on first user response 28.

Optionally, combination device 16 is responsive to first server reply 30 being received by combination device 16 by way of sending a second user response 32 to sending message server 16.

Preferably, second user response 32 is selected from the group consisting of: an automatic response, a stealth response, a response actuated by visual indicator 20, a response actuated by first binary responder 22, a response actuated by second binary responder 24 and a response actuated by at least one general responder 26.

Optionally, sending message server 12 receives second user response 32 and processes data included therein without performing a transmission to combination device 16 in response to receiving first user response 28.

Preferably and substantially thereafter, sending message server 12 receives second user response 32, sending message server 12 is responsive to second user response 32 and sends a second server reply 34 created by sending message server 12 based on second user response 32.

Optionally, triggering electronic signal packet 14 and first user response 28 include “stealth” electronic signal packet or “silent” electronic signals such that combination device 16 does not show any exterior signals, audio or visual signs to having received triggering electronic signal packet 14 or having sent first user response 28.

According to a preferred embodiment of the present invention, preferably, occasioning on triggering electronic signal packet 14 and first user response 28 including “stealth” electronic signal packet or “silent” electronic signals, combination device 16 is responsive to first server reply 30 by way of actuating hardware interface 18 and readily facilitating a user to send second user response 32 with a single activation of first binary responder 22, second binary responder 24 or at least one general responder 26.

Preferably, substantially thereafter, activation of first binary responder 22 optionally sends a “yes” or a “1” style second user response 32 to sending message server 12 whilst activation of second binary responder 24 optionally sends a “no” or a “0” style second user response 32 to sending message server 12.

Optionally, activation of at least one general responder 26 optionally sends an “other” or a “2” style second user response 32 to sending message server 12.

Optionally, at least one general responder readily facilitates a user to send a second user response 32 including an alphanumeric string selected from a predetermined set of alphanumerical strings or a user generated alphanumerical string or text.

According to a preferred embodiment of the present invention, sending message server 12 preferably analyses first user response 28 for the purpose of creating a database based on a multiplicity of first user response 28 sent from a multiplicity of user in response sorted according to the type of triggering electronic signal packet 14 sent. Occasioning on triggering electronic signal packet 14 and/or first user response 28 matching a predetermined set of parameters, first server reply 30 includes a data reward deemed beneficial to the user of combination device 16.

Preferably, first user response 28 and triggering electronic signal packet 14 are wireless electronic signals.

Preferably, first server reply 30 and second user response 32 are wireless electronic signals

According to a preferred embodiment of the present invention, occasioning on triggering electronic signal packet 14 and first user response 28 including “stealth” electronic signal packet or “silent” electronic signals, sending message server 12 preferably analyses second user response 32 for the purpose of creating a database based on a multiplicity of second user response 28 sent from a multiplicity of users, sorted according to the type of first server reply 30 sent. Occasioning on first server reply 30 and/or second user response 28 matching a predetermined set of parameters, second server reply 34 includes a data reward deemed beneficial to the user of combination device 16.

In use, a multiplicity of sending message server 12 designs are envisaged and many similar interactions between sending message server 12 and combination device 16 would be apparent to an artisan as well as many variations, modifications and other methods of use of the invention may be made.

By way of a non-limiting example only, sending message server 12 and combination device 16 are readily adaptable to a wide range of applications, including but not limited to, medical questionnaires which are invariably inefficient in collecting vital medical and/or patient data.

Optionally, combination device 16 is a cellular communications device readily facilitates actuation of a component selected from the group consisting of: a visual indicator 20, a first binary responder 22, a second binary responder 22 and at least one general responder 26.

Preferably, substantially subsequently to combination device 16 receiving at least one triggering electronic signal packet 14, including a question for a patient general responder 26 registered in combination system 10 the patient utilizes device 16 to send a first user response 28 response actuated by at patient general responder 26 to sending message server 16.

Preferably and substantially thereafter, sending message server 12 receives first user response 28, sending message server 12 is responsive to first user response 28 and sends a first server reply 30 created by sending message server 12 based on first user response 28.

Preferably, first server reply 30 includes beneficial packets to patient general responder 26.

The term “beneficial packets” as used herein, includes but is not limited to, information beneficial to patient general responder 26, remedial information pertaining to patient general responder 26 news regarding developments in the field of ailments suffered by to patient general responder 26, coupons and vouchers for items, medications and pharmaceuticals used by to patient general responder 26 and the like.

Optionally, combination device 16 is responsive to first server reply 30 being received by combination device 16 by way of sending a second user response 32 to sending message server 12.

Optionally, triggering electronic signal packet 14 and first user response 28 include “stealth” electronic signal packet or “silent” electronic signals such that combination device 16 does not show any exterior signals, audio or visual signs to having received triggering electronic signal packet 14 or having sent first user response 28. Thus, sending message server 12 is responsive to first user response 28 wherein first user response 28 includes but is not limited to geolocation of patient general responder 26, physical activity levels of patient general responder 26, combination device 16 activation and/or operation levels of patient general responder 26.

Thus, sending message server 12 readily facilitates generation of personalized interactive “Push Notifications” for sending to a patient general responder 26, a select group of patient general responder 26 and “All Points” interactive “Push Notifications” to a plurality of patient general responders 26.

While the invention has been described with respect to a limited number of embodiments, it will be appreciated that many variations, modifications and other applications of the invention may be made.

What is claimed is:

1. A combination system comprising:
(a) a sending message server;
(b) at least one triggering signal packet sent from said sending message server; and
(c) a combination device responsive to receiving said at least one triggering signal packet.

2. The combination system of claim 1, wherein said combination device further comprising a hardware interface.

3. The combination system of claim 2, wherein said hardware interface further comprising a visual indicator.

4. The combination system of claim 2, wherein said hardware interface further comprising a first binary responder and a second binary responder.

5. The combination system of claim 1 wherein substantially subsequently to said combination device receiving said at least one triggering electronic signal packet, said combination device sends a first user response to said sending message server.

6. The combination system of claim 5 wherein first user response to said sending message server is selected from the group consisting of: an automatic response, a stealth response, a response actuated by a visual indicator, a response actuated by said first binary responder, a response actuated by said second binary responder and a response actuated by at least one general responder.

7. The combination system of claim 5 wherein said sending message server sends a first server reply in response to first sending server receiving said first user response.

8. The combination system of claim 5 further comprising a second user response selected from the group consisting of: an automatic response, a stealth response, a response actuated by said visual indicator, a response actuated by said first binary responder, a response actuated by said second binary responder and a response actuated by said at least one general responder.

9. The combination system of claim 6 wherein said sending message server sends a first server reply in response to first sending server receiving said first user response.

10. The combination system of claim 6 further comprising a second user response selected from the group consisting of: an automatic response, a stealth response, a response actuated by said visual indicator, a response actuated by said first binary responder, a response actuated by said second binary responder and a response actuated by said at least one general responder.
